(19) United States
(12) Patent Application Publication
(10) Pub. No.: US 2017/0332804 A1
(43) Pub. Date: Nov. 23, 2017

(54) UPHOLSTERED FURNITURE SYSTEM COMPRISING AN ITEM OF UPHOLSTERED FURNITURE AND A CONTROL SYSTEM, AND METHOD FOR OPERATING AN UPHOLSTERED FURNITURE SYSTEM

(71) Applicant: ROM AG, Eupen (BE)

(72) Inventor: Paul ROM, Eupen (BE)

(73) Assignee: ROM AG, EUPEN (BE)

(21) Appl. No.: 15/521,302

(22) PCT Filed: Oct. 27, 2015
(86) PCT No.: PCT/EP2015/074802

§ 371 Date: Apr. 24, 2017

(30) Foreign Application Priority Data
Oct. 28, 2014 (DE) 10 2014 115 641.2

(51) Int. Cl. A47C 31/00; A47C 7/46; A61H 99/00; A47C 1/02; A47C 7/24; A47C 7/74; H02J 7/00

(52) U.S. Cl. CPC A47C 31/008; A47C 7/24; A47C 7/46; A47C 7/748; A61H 99/00; A47C 1/02; A61H 2201/5028; A61H 2201/5007; A61H 2201/1207; A61H 2201/0207; A61H 2201/5035; A61H 2201/5043; A61H 2201/5061; A61H 2201/5097; H02J 2007/0062; H02J 7/0052

(57) ABSTRACT

An upholstered furniture system includes an item of upholstered furniture. The item of upholstered furniture includes electrical functions, at least one seating element, and a control system. The control system includes a mobile input device, a communications terminal, and at least one control unit arranged on the item of upholstered furniture. The at least one control unit is operatively connected to the communications terminal.

### CROSS REFERENCE TO PRIOR APPLICATIONS

This application is a U.S. National Phase application under 35 U.S.C. §371 of International Application No. PCT/EP2015/074802, filed on Oct. 27, 2015 and which claims benefit to German Patent Application No. 10 2014 115 641.2, filed on Oct. 28, 2014. The International Application was published in German on May 6, 2016 as WO 2016/066607 A1 under PCT Article 21(2).

### FIELD

The present invention relates to an upholstered furniture system comprising an item of upholstered furniture and a control system.

### BACKGROUND

Upholstered furniture systems of this kind have previously been described. A disadvantage with known upholstered furniture systems is that they are expensive to manufacture or that their control cannot be realized in a versatile or convenient manner to the extent desired.

### SUMMARY

An aspect of the present invention is to provide an upholstered furniture system which is improved at least with regard to one of the above stated disadvantages. Another aspect of the present invention is to provide a method for operating an upholstered furniture system.

In an embodiment, the present invention provides an upholstered furniture system which includes an item of upholstered furniture. The item of upholstered furniture comprises electrical functions, at least one seating element, and a control system. The control system comprises a mobile input device, a communications terminal, and at least one control unit arranged on the item of upholstered furniture. The at least one control unit is operatively connected to the communications terminal.

### BRIEF DESCRIPTION OF THE DRAWINGS

The present invention is described in greater detail below on the basis of embodiments and of the drawings in which:

FIG. 1 shows a schematic diagram of an exemplary embodiment of an upholstered furniture system viewed from above;

FIG. 2 shows a schematic diagram of a control unit;

FIG. 3 shows a diagram of the dependence between the signals of the second pushbutton board, the signal of the seat-occupied sensor, and the power applied to the seat heating;

FIG. 4 shows a schematic of a possible standby function of a control unit;

FIG. 5 shows the assignment of the electrical cable;

FIG. 6 shows a perspective view of an exemplary embodiment of the upholstered furniture system according to the present invention with an item of upholstered furniture and set-up device;

FIG. 7 schematically shows a functionality of the control elements of call-up devices;

FIG. 8 schematically shows a functionality of the control elements of call-up devices where the calling-up of a state which has already been set up and stored;

FIG. 9 schematically shows a functionality of the control elements of call-up devices where the option of returning the upholstered furniture to the starting position is clarified;

FIG. 10 schematically shows a functionality of the control elements of call-up devices where no set-up device which is separate from the call-up device is provided;

FIG. 11 schematically shows a functionality of the control elements of call-up devices where the call-up actuating device and a set-up actuating device are simultaneously actuated and held;

FIG. 12 schematically shows a functionality of the set-up actuating devices where a movement of a section of the upholstered furniture in one of two opposing directions and a locking of this section in a plurality of intermediate positions is controlled with one of two set-up actuating devices;

FIG. 13 schematically shows a functionality of the set-up actuating devices where a movement of a section of the upholstered furniture in one of two opposing directions and a locking of this section in a plurality of intermediate positions is controlled with one of two set-up actuating devices;

FIG. 14 shows a view of a circuit board of a call-up device with electrical cable and plug;

FIG. 15 shows a perspective view of the plug from FIG. 14.

### DETAILED DESCRIPTION

The upholstered furniture system according to the present invention comprises an item of upholstered furniture and a control system. The item of upholstered furniture includes at least one seating element. The item of upholstered furniture has electrical functions. The item of upholstered furniture can therefore also be described as functional upholstered furniture.

The control system includes at least one mobile input device. The control system includes a communications terminal. The control system also includes at least one control unit which is arranged on the item of upholstered furniture, is operatively connected to the communications terminal and which can, for example, control the electrical functions of the item of upholstered furniture.

The operative connection between the communications terminal and the at least one control unit can, for example, be hard-wired.

The control unit can also be described as a control box and can, for example, be separate from the communications terminal.

The communications terminal can, for example, be arranged on the item of upholstered furniture. The communications terminal can also be described as a communications box.

The mobile input device can, for example, be a commercially available smartphone or a commercially available tablet computer. This has the advantage that the mobile input device is already available to many users and does not always need to be purchased separately.

The control system can, for example, include software which acts together with a mobile input device and which can, for example, work on the mobile input device. The software can, for example, comprise a so-called “App.”

The control system can, for example, include a wireless connection between the mobile input device and the communications terminal. The wireless connection can, for example, be in the form of a radio link and can, for example, include a wireless network (i.e., a WLAN) which can, for example, be Wi-Fi certified.

A plurality of control units can, for example, be provided. One control unit can, for example, undertake the complete activation of a seating element.

The upholstered furniture system can include different control units which can have different levels of expansion. The upholstered furniture system can, for example, include identical control units, for example, with dockable additional modules.

The communications terminal can, for example, provide a Wi-Fi connection (i.e., a so-called “access point”) into which a plurality of different mobile input devices, for example, up to eight different mobile input devices, can dial. One communications terminal can advantageously be provided for each item of furniture.

The software can advantageously provide a complete visual portrayal of the upholstered furniture. The software can, for example, have authorization to access the communications terminal. It can be advantageous to be necessary to configure the communications terminal (for example, only for authorization). The configuration of the communications terminal can advantageously be carried out on initial commissioning, either in the factory or by the user with special configuration software.

The item of upholstered furniture can advantageously include a plurality of seating elements with, for example, one control unit being provided for each seating element.

In the embodiment with a plurality of seating elements, the seating elements can, for example, be networked with one another. It is thereby meant in particular that means are provided to transmit information from one seating element to another seating element. These means can, for example, comprise electrical cables. The seating elements can, for example, therefore be cabled to one another. An exchange of information can, for example, occur between the seating elements. Means can, for example, be provided to transmit energy between the seating elements. These means can advantageously comprise electrical cables.

The item of upholstered furniture can be an armchair or a sofa, for example, a corner sofa.

Each seating element of the upholstered furniture can, for example, have just one control unit for each seating element. This can, for example, control the respective electrical functions of this seating element.

In the embodiment in which a plurality of control units is provided, the communications terminal can advantageously be operatively connected to the control units by a bus system. The bus system is also referred to as “bus” herein.

The seating elements can, for example, be connected by an electrical connecting cable to the operating voltage, for example, to the bus. The control units function as so-called “slaves” in this bus system. The control units can, for example, only serve the bus when they are required to do so.

In an embodiment of the present invention, possible mechanical collisions between the individual seating elements, for example, two elements which are at an angle to one another and which each have a footrest function, can, for example, be detected by the control system. The upholstered furniture can advantageously be configured so that collisions of this kind cannot occur.

The communications terminal can, for example, function in the bus system as a so-called “master.” The communications terminal can advantageously be arranged on one of the two end seating elements of the upholstered furniture. It is thereby easily accessible and can be arranged either in a housing which is visible to the user, or arranged behind and/or beneath the upholstered furniture or fitted inside the upholstered furniture.

The communications terminal can, for example, be capable of controlling the entire upholstered furniture via the bus. Each seating element can, for example, be assigned an address (in the case of eight seating elements, 1 to 8). Each address can, for example, only be assigned once, and can, for example, be set before final assembly. The addresses can advantageously be assigned in a clockwise direction. The entire upholstered furniture can, for example, be controlled via the Wi-Fi connection with the mobile input device, for example, a smartphone or/and a tablet computer.

The control system can, for example, include at least one local input device and each local input device can, for example, be connected to just one control unit. The user therefore has the possibility, for example, for each seating element with electrical function, of choosing between two basically different input options, namely, the mobile input device and the local input device which is arranged locally and captive on the furniture. The operative connection between the control unit and the local input device can, for example, be realized with the help of an electrical control cable.

The local input device can comprise a pushbutton board which can be arranged immediately on the control device. In an embodiment, the communications terminal is not operatively connected to a local input device which is permanently arranged on the furniture. Two different pushbutton boards can be provided in order to take into account different configurations of the upholstered furniture system. A first pushbutton board can be provided which can include up to four buttons, for example, snap-action buttons. A second pushbutton board can be provided which can include up to two buttons.

The electrical functions of the upholstered furniture can, for example, include motorized adjustability of at least one seating element. The electrical functions of the upholstered furniture can also, for example, include a massage function of at least one seating element. The electrical functions of the upholstered furniture can also, for example, include seat heating of at least one seating element. The electrical functions of the upholstered furniture can, for example, also include at least one optionally activatable and, for example, also adjustable lumbar support of at least one seating element. The electrical functions of the upholstered furniture can advantageously include at least one USB charging unit. The electrical functions of the upholstered furniture can, for example, include a seat-occupied sensor of at least one seating element. The seat-occupied sensor can also be described as a seat-occupied pad.

In order to realize the motorized adjustability feature, the upholstered furniture can advantageously include motors, for example, electric motors, for example, one or two electric motors for each seating element. At least one seating element of the upholstered furniture can advantageously include a headrest. The first motor of the motorized adjustability feature can, for example, be provided for the headrest. At least one seating element of the upholstered furniture can advantageously have a footrest. The second motor of the motorized adjustability feature can advantageously be provided for the footrest.

The control device can advantageously be configured vos the two pushbutton boards. The second pushbutton board can, for example, only be necessary when the respective seating element has seat heating and/or a massage unit. The local input device includes the second pushbutton board, advantageously in combination with the first pushbutton board. Button one and button two of the first pushbutton board can control a first motor of the motorized adjustability feature of a seating element, and button three and button four of this pushbutton board can control a second motor of the motorized adjustability feature of this seating element.

In an embodiment of the present invention, just one button, for example, of the first pushbutton board can, for example, control just one motor of the motorized adjustability feature of a seating element or just one motor-adjustable section of the upholstered furniture. Instead of providing a button for motorized opening and a button for motorized closing of a fitting of the adjustable section, one and the same button opens and closes the fitting. Just one button therefore controls both movement directions of a motor-adjustable section of the upholstered furniture. This can advantageously occur so that the fitting opens when the button is pressed, the fitting closes again when the button is pressed for a second time, and the fitting opens again when the button is pressed for a third time, etc.

The buttons of the first pushbutton board can, for example, therefore serve to adjust the position of sections of the upholstered furniture and can also be described as “set-up switches.”

Button one of the second pushbutton board can switch the massage unit of this seating element on and off, for example, in a changeover mode, a so-called “toggle operation”. Button two of the second pushbutton board can switch the seat heating on and off, for example, in changeover mode, so-called “toggle operation”. The first pushbutton board can be provided in different embodiments which are adapted to suit the equipment of the respective seating element.

The upholstered furniture can, for example, advantageously have a USB charging socket for charging a smartphone or tablet computer. A USB charging unit can advantageously not be provided on every seating element. The control unit can advantageously provide a voltage supply for a USB charging unit which may be present. The USB charging unit can, for example, include a voltage regulator board and a USB socket.

Just one, for example, multi-core, electrical connecting cable can advantageously be provided between two control units. An electrical connecting cable can likewise advantageously be provided between the communications terminal and one, for example, just one, control unit. The electrical connecting cables between two control units and, for example, also between the communications terminal and the control unit can, for example, be six-core. The bus system can, for example, be realized and the power supply for the control units can, for example, be established with the help of the electrical connecting cable.

Two cores of the electrical connecting cable (V+ and GND) can, for example, be used in parallel in order to cope with the encountered total current.

The motors, via which the motorized adjustability feature is provided, can be connected to a control unit via an electrical cable.

The seat heating for each seating element can be realized with the help of two heating mats which can be connected in series. The respective control unit can provide a pulsed DC signal as an output for the heating.

The massage function can be realized with the help of pumps, which pump up the air cushions.

The control unit can control the massage via an output. In order to operate the massage control without communications terminal, only one button, which, for example, starts or stops the automatic massage program, can, for example, be provided on the first pushbutton board or, for example, on the second pushbutton board. The massage program can, for example, be started by the first actuation of the button. Actuating this switch again, or the expiry of ten minutes, can, for example, stop the massage program. All air cushions can, for example, be deflated when the massage program has ended. Individual air cushions of the massage device can advantageously be actuated by the communications terminal.

The upholstered furniture can advantageously have a buzzer as a signaling device for the user. This can emit two or more different signal tones depending on whether or not a user input has been correctly recognized and can be carried out.

The communications terminal can incorporate at least one temperature sensor. The communications terminal can, for example, have a room-temperature temperature sensor and/or a seat-heating temperature sensor. Particularly in the embodiment in which the communications terminal is fitted inside the upholstered furniture, an external temperature sensor, particularly for measuring the room temperature, which can be arranged, for example, on or in the vicinity of the surface of the upholstered furniture, can be connected to the communications terminal. A seating mat with temperature sensor can in particular be provided to measure the temperature of the seat heating. This seating mat can be the seat heating or a mat arranged in the vicinity of the seat heating.

The motorized adjustability feature of a seating element can advantageously be effected by at least one electric motor which has at least one sensor, for example, a Hall sensor, to measure the actual motor position. The motorized adjustability feature of a seating element can advantageously be effected by two electric motors which both have two sensors, in particular Hall sensors, to measure the actual motor position. Each Hall sensor can, for example, output a defined number of pulses per motor revolution and, advantageously, a controller which counts the pulses provided. If, for example, two sensors which are offset by 90° are placed in the motor, the direction of rotation is also detected as the counter state increases or depletes. The position can, for example, be determined based on the counter state. The counter state can, for example, be stored in the controller in a non-volatile secure manner when the motor travel is complete. Memory positions can, for example, be stored and thereby approached again later. A reference movement can advantageously take place during commissioning and in the event of a fault, for example, after an unexpected supply failure during a motor movement. Each motor can advantageously have an end position switch. The end position switch of the motor can, for example, form the reference point. The end position can advantageously correspond to a starting position of the upholstered furniture. A “zero value correction” of the Hall counter value can advantageously occur again automatically every time this starting position, which can be defined, for example, in that the footrest is closed, i.e., moved back or retracted, and the headrest is straight, is reached. A relay can advantageously be provided which short-circuits the at least one motor at standstill, thereby causing a braking effect against lowering under load. The control system can advantageously include a memory function for at least one seating element so that a position of the motorized adjustment of this seating element selected by the user is stored and can be recalled.

A memory function can advantageously be called up both via the local input device and via the mobile input device. Each control unit can advantageously store at least two memory positions which can be called up via the local input device. Each control unit can, for example, store at least five memory positions which can, for example, be called up via the local input device. The second memory position can here include the position for both motors, and the first memory position only the position for the headrest motor. The memory positions which can be actuated via the mobile input device can advantageously be stored in the mobile input device. Each user can, for example, define his/her own memory positions, for example, in a personal smartphone or tablet computer. The positions to be approached can, for example, be transmitted by commands from the communications terminal to the respective control unit. The motors can, for example, be moved to the appropriate position in order to program a memory position. This position can then, for example, be stored by operating a particular button of the first pushbutton board. In doing so, the previously stored position can, for example, be overwritten.

The control system can advantageously include automatic activation and deactivation of the seat heating depending on signals of the seat-occupied sensor. The heating can, for example, be switched on and off, for example, via the mobile input device or the local input device. After switching on, the seat heating can advantageously be heated for a certain period, for example, for three minutes, and then held at the temperature. The seat heating can advantageously be automatically switched off when the seat-occupied sensor signals that the seating element has been vacated by the user. In an embodiment, the automatic switch-off can, for example, not occur until after a certain time, for example, ten minutes, after the seat-occupied sensor signals that the user has vacated the seating element.

The control system can advantageously include a so-called lock principle which prevents the simultaneous access of a plurality of mobile input devices to the same seating element. Operating conflicts are thereby advantageously prevented, for example, when two different mobile input devices want to simultaneously access just one seating element in different ways. The lock principle can advantageously be switched off so that access by one mobile input device is refused as soon as the software of another mobile input device for this seating element has logged in. Advantageously, it is also possible that the software of a mobile input device logs in for a plurality of seating elements or even for the entire upholstered furniture. In order to avoid software being logged in for one or more seating elements, each software package can advantageously also request a release of seating elements. If the logged-in software does not object to this release, as it is out of range, for example, or the battery of the mobile input device is flat, the release advantageously occurs. In order to avoid operating conflicts within an individual seating element, the local input device for each control unit can, for example, have priority over any mobile input devices.

The upholstered furniture system can, for example, include at least one power supply arranged on the upholstered furniture. Each control unit can, for example, be connected to a power supply. Fewer power supplies than control units can advantageously be provided. A plurality of control units can, therefore, for example, share a common power supply. Just one power supply can, for example, be provided for each item of furniture or just two power supplies can, for example, be provided for each item of furniture. The connection between power supply and control unit can, for example, be provided so that the at least one power supply is connected to just one control unit or to just two control units via an electrical connecting cable. The power supply for the control units can, for example, also be looped through with the bus signal.

The control unit can also be described as a supply control unit because it, for example, supplies energy to connected consumers, for example, the electric motors which realize the motorized adjustability feature.

The seating elements of the upholstered furniture are advantageously therefore not only mechanically but also electrically connected to one another.

The upholstered furniture can advantageously also have seating elements without electrical functions. Advantageously, these do not include a control unit and are, for example, bridged. The upholstered furniture can advantageously include up to eight seating elements. The power supply can advantageously be arranged in the middle of the upholstered furniture in order to keep voltage drops as small as possible. The power supply can, for example, have a Y-connector.

In an embodiment of the present invention, the control system can, for example, include a connection of the mobile input device to a server of the upholstered furniture's manufacturer. This connection can, for example, be made with the help of the software. As the software is not always available, for example, when it works on a mobile input device and there is no mobile input device in the vicinity, the communications terminal in this embodiment can, for example, have a data memory. This can, for example, be capable of storing mass data. The communications terminal advantageously has an SD card for this purpose. The communications terminal advantageously has a back-up battery and, advantageously, stores date and time with the help of a real-time clock. The time can, for example, be set and synchronized via the software and passed to the control units via the bus. Each action of the seating element can be locally buffered in the control unit with date and time. For example, it is possible to store when which motor of the upholstered furniture system has run and/or when which sensor of the upholstered furniture system has measured which value and/or when how much current has been consumed by the upholstered furniture system and/or when and how long which seat heating of the upholstered furniture system was switched on. These data can be called up in rotation via the communications terminal and can be stored on the SD card with the address of the control unit. This data packet can then be retrieved from the communications terminal and sent to the manufacturer's server by the software, which can, for example, work on the mobile input device. Data can here be recorded which are suitable for use for diagnostic purposes and/or technical problems and/or to be able to determine and recommend maintenance intervals (for example, as a combination of “occupied time” and “utilization time”) and/or, at the request of the furniture trade, to be able to send specific product recommendations to the user based on recorded behavior schemes. Data which are suitable for carrying out behavior research can also be recorded.

In an embodiment of the present invention, the software can, for example, access the individual operating instructions of the upholstered furniture system, which can, for example, contain care information and troubleshooting. The software can allow a chat with customer service and enable contact with the dealer on all usual channels. The software can include a time display with an alarm function. The alarm function can consist in all motorized functions of the upholstered furniture being extended and retracted for a short time so that a user who may have fallen asleep on the upholstered furniture wakes up.

The control system can advantageously include an energy management feature. In an embodiment, each motor of the motorized adjustability feature requires up to 5 A when loaded. In an embodiment, the seat heating requires approximately 2.5 A, the massage unit 1 A, and the USB charging unit 0.5 A. The energy management feature can, for example, reduce the maximum current that the power supply must deliver. The current for the motors, the seat heating, the massage unit, and the USB charging unit can advantageously be measured for this purpose. Each control unit can also advantageously measure the operating voltage. In an embodiment, the headrest motor current is limited to 2 A by the energy management feature. At greater currents, the motor can, for example, switch off. Alternatively or in addition thereto, the seat heating switches off for the time that a motor is moved. Alternatively or in addition thereto, the seat heating can be switched off by the energy management feature for as long as the operating voltage falls below a certain value.

Two or more power supplies can basically be provided for each item of upholstered furniture.

It is basically conceivable to supply power for the upholstered furniture via a battery.

In an embodiment of the present invention, the total occupancy duration of the seat-occupied sensor can, for example, be indicated, for example, audibly. When a particular button on the local input device is actuated for a certain time, for example, the total occupancy duration of the seat-occupied sensor can be indicated audibly in that a signal tone occurs for one hundred full hours of utilization.

The upholstered furniture system can advantageously include an item of upholstered furniture which has electrical functions and which can assume different states. At least one device can, for example, be provided for setting up the different states and, for example, a storage device is provided for storing the different states. In addition thereto, at least one device can, for example, be provided for calling up the stored states. Within the framework of this publication, the device for setting up the different states is also described as a set-up device, the storage device for storing the different states is also described as storage means, and, the device for calling up the stored states is also described as a call-up device.

Within the framework of this publication, the term “setting up a state” in particular means that the upholstered furniture is brought into the required state and the command for storing this state is issued.

A required state of the upholstered furniture can advantageously be set, advantageously steplessly, with regard to the position of sections of the upholstered furniture with the help of the set-up device, and this state can, for example, be stored with the help of the set-up device.

The term “calling up a state” within the framework of this publication in particular means that the command is issued that the upholstered furniture should automatically assume an already stored state. In the case of a plurality of stored states, this in particular also means that the required state is selected in advance from the plurality of stored states.

The automatic assumption by the upholstered furniture of a state stored in advance can, for example, be effected with the help of the call-up device. In the case of a plurality of stored states, the required state can be selected in advance, for example, from the plurality of stored states, with the help of the call-up device.

Within the framework of this publication, the upholstered furniture is also abbreviated as furniture, which can advantageously include a sofa or an armchair. As the upholstered furniture has electrical functions, it can also be described as functional upholstered furniture.

The call-up device can, for example, be separate from the set-up device. A set-up device, which is separate from the call-up device, is therefore, for example, provided. The stored states can, for example, be called up by a different device from that with which they were set up.

It has been shown that, when setting up a state, different requirements from when calling up an already set-up and stored state are placed on the appropriate device. This is because a certain complexity, which enables the different states to be set up quickly, accurately, and intuitively is, for example, desirable during set-up. It has been shown that complexity of this kind is not required when calling up. If the call-up device is separate from the set-up device, i.e., it is not one and the same device, this creates a prerequisite for taking into account the different requirements. This enables greater user convenience and improved visual appearance of the furniture to be achieved, for example, by a simply constructed call-up device, and yet enables rapid and accurate setting up of the states by a complex set-up device.

The call-up device is advantageously less complicated and, for example, less complicated to operate than the set-up device.

The preferences regarding the way in which the upholstered furniture is to assume the required state can advantageously also be entered with the set-up device.

In an embodiment of the present invention, a device can, for example, be provided in which are stored the preferences of the user regarding the way in which the upholstered furniture is to assume the respective state for each state stored via the storage means. For example, whether the position of the backrest or the position of the footrest is changed first, or whether this occurs simultaneously, is here stored. This device can, for example, be identical to the storage means.

The storage means can be associated with the set-up device and/or the call-up device. In order to be also able to call up states independently of the set-up device, the storage means are advantageously arranged on the upholstered furniture and, for example, associated with the call-up device. The storage means can be associated with the communications terminal. The storage means can be part of the communications terminal.

Within the framework of this publication, the term “seating element” in particular means the section of the upholstered furniture which is intended for the use, for example, at least including sitting, of just one user. The seating element can include a seat and/or a backrest and/or a footrest and/or a headrest. The seating element can have a heater, for example, seat heating, and/or a massage function and/or lighting.

All or individual components of the seating element can be set to different positions by motors.

The electrical functions of the upholstered furniture can, for example, include motorized adjustability of at least one seating element. The electrical functions of the upholstered furniture can, for example, also include a massage function of at least one seating element. The electrical functions of the upholstered furniture can, for example, also include seat heating of at least one seating element. The electrical functions of the upholstered furniture can, for example, also include at least one optionally activatable and, for example, also adjustable lumbar support of at least one seating element. The electrical functions of the upholstered furniture advantageously includes at least one USB charging unit. The electrical functions of the upholstered furniture can, for example, include a seat-occupied sensor of at least one seating element. The seat-occupied sensor can also be described as a seat-occupied pad.

In order to realize the motorized adjustability feature, the upholstered furniture advantageously includes motors, for example, electric motors, for example, one or two or more electric motors for each seating element. The at least one seating element of the upholstered furniture advantageously includes a headrest. One motor, or the first motor of the motorized adjustability feature, can, for example, be provided for the headrest. At least one seating element of the upholstered furniture can advantageously have a footrest. One motor, or the second motor of the motorized adjustability feature, is advantageously provided for the footrest. If, as is basically conceivable, the seating element has an adjustable backrest, then one motor of the motorized adjustability feature can, for example, be provided for the backrest.

The different states can, for example, differ from one another by different positions of sections of the upholstered furniture, for example, of the backrest. Alternatively or in addition thereto, they can also differ from one another by different operating states of devices of the upholstered furniture system, for example, a heater (for example, seat heating) and/or massage function device, and/or lighting.

These different states can, for example, be adapted to suit different users and/or different situations (for example, reading, watching television, reclining or starting heating). The different states can be stored together with information regarding the user for which they are intended and/or the situation for which they are intended.

The setting-up of the states can, for example, include the setting-up of the required state, i.e., the actual bringing of the furniture into the required state and confirmation thereof.

The set-up device can also be described as an input device.

It is basically conceivable that a state can also be called up with the set-up device. It is basically conceivable that a state can also be set up with the call-up device. In an embodiment, however, a state cannot be set up with the call-up device and, in this embodiment, only states which have already been stored can be called up with the call-up device.

The set-up device can advantageously have a plurality of actuating devices, for example, separate actuating devices. The set-up device can, for example, have its own housing. The set-up device can, for example, be spatially separate or separable from the furniture, and can, for example, be arranged on the call-up device.

The call-up device can, for example, not have a device for visually reproducing changing functions. The call-up device can, for example, not have a display.

Setting up the different states can be particularly convenient if the set-up device does not have a device for visually reproducing changing information. The device can include lamps, for example LEDs, which illuminate, for example, when an end position is reached.

The set-up device can constitute a complete visual portrayal of the upholstered furniture, for example, in the state assumed at a particular time, for example, enriched with symbols which enable the electrical functions to be distinguished.

The device for visually reproducing changing information can include a display. The set-up device can therefore have a display. The display can be touch-sensitive. The display can therefore also be an actuating device. In the embodiment in which the visual portrayal of the upholstered furniture is shown, the display can include an actuating device so that the user taps the section of the upholstered furniture which he wants to adjust and, if necessary, moves it in the direction in which he/she requires an adjustment.

It is basically conceivable that the set-up device is arranged permanently on the upholstered furniture. It can, for example, be moved relative thereto. It can be connected to the upholstered furniture with the help of a cable.

The upholstered furniture can have a storage place for the set-up device which cannot be discerned from the outside.

The set-up device can, for example, be operatively connected to the rest of the upholstered furniture system, for example, exclusively, with the help of a radio link.

The set-up device can, for example, include the mobile input device or be formed thereby. The mobile input device can advantageously be moved relative to the upholstered furniture and, for example, is not mechanically, and, for example, also not galvanically, connected thereto. The mobile input device can comprise a remote control or be formed thereby. The mobile input device can, for example, comprise a commercially available smartphone and/or a commercially available tablet computer or be formed thereby.

The system can have a plurality of identical and/or different mobile input devices.

The call-up device can, for example, be associated with the upholstered furniture. The upholstered furniture can have a plurality of call-up devices or just one call-up device. The upholstered furniture can have a plurality of call-up devices for each seating element. The upholstered furniture can, for example, have just one call-up device for each seating element which, can, for example, be arranged on the rest of the upholstered furniture. It is basically conceivable for it to be movably arranged on the furniture, for example, connected via a cable. The call-up device can, for example, be permanently arranged on the furniture, i.e., immovable with respect thereto. The call-up device can, for example, include the local input device or be formed thereby. The local input device can, for example, be arranged locally and captive on the furniture, advantageously immovable with respect thereto.

The call-up device can, for example, include a call-up actuating device which can, for example, include a call-up switch or be formed by a call-up switch.

The call-up device can have a plurality of call-up actuating devices. In an embodiment, the call-up device has just one call-up actuating device.

The call-up actuating device can have a plurality of call-up switches. The call-up actuating device advantageously has just one call-up switch. This enables the call-up device to be integrated into the furniture particularly attractively.

The call-up device can, for example, be arranged directly on the seat of the furniture, for example, in the upholstery. The call-up device can, for example, have an actuating device which, advantageously, can be reached by a user sitting or lying on the furniture.

The call-up switch can, for example, allow just two switch settings. This enables stored states to be called up particularly easily. It is basically conceivable that the call-up switch includes a changeover switch (on-on). The call-up switch can, for example, include an on switch (on-off) or be formed thereby. The call-up switch can, for example, switch electrical current after operation, for example, after mechanical, for example, manual, operation.

The call-up switch advantageously includes a switching element and, further advantageously, an actuating part. The actuating part is advantageously arranged on the switching element. The transmission between switching element and actuating part advantageously takes place mechanically. The call-up switch advantageously includes a press switch, for example, a pushbutton. The call-up switch advantageously closes the contact only for as long as it is actuated. In the non-actuated state, the call-up switch can, for example, make no electrical connection. The call-up switch advantageously includes a pushbutton which can, for example, also be described as an “ident button.”

Within the framework of this publication, a “press switch” is in particular described as a switch in which the switching operation assumes that a force is exerted by the user, unlike, for example, a so-called “touch switch”. The press switch can, for example, be a so-called snap-action switch. The press switch can, for example, include a printed circuit board and at least one pushbutton switch, for example, on the snap-action principle. The pushbutton switch can, for example, have a force-displacement characteristic which exhibits distinct hysteresis. The call-up switch can include a return spring. The return spring can, for example, return the call-up switch to the starting position after actuation.

A device is advantageously provided which assigns just one predetermined state of the stored states to a particular number of repeated actuations of the call-up actuating device, for example, within a certain time period. For example, this assignment device links a double consecutive actuation of the call-up device, within a certain time period, with the state stored in position two. The order of the stored states can, for example, be defined by the set-up device. This assignment device can, for example, include an electronic circuit, for example, an integrated circuit, which can, for example, be arranged permanently on the call-up device and/or the item of furniture.

Individual states, i.e., specific to just one user, can, for example, be set up with the help of the set-up device.

The states can, for example, be stored with the help of the storage means, for example, via the set-up device and/or the call-up device.

The states can, for example, be called up semi-automatically. This means in particular that the states are automatically assumed by the upholstered furniture after being called up by the call-up device. The states can, for example, be called up with the help of the call-up device, for example, without the set-up device.

In the case of a plurality of users, the states which are set up for different users can be stored “consecutively.” When calling up, the user can therefore first “scroll” through the states stored for just one user via the call-up device and then through the states stored for another user.

The system can include a display which indicates to the user the user with which the selected state is associated. The display can include lamps in different colors or in different positions, and/or tone generators which can produce tones at different levels.

The call-up device can include a plurality of call-up actuating devices, for example, one dedicated to each user, for example, just two, or just three, or just four.

The call-up actuating device can have user identifications, for example, a fingerprint sensor or similar, integrated into the call-up switch.

It is basically conceivable that a changeover device is provided, which enables a changeover between the states stored for different users, and a call-up actuating device is provided, which is separate therefrom, which enables a selection from a plurality of states stored for the same user.

It is conceivable that a first call-up device, which can be assigned to a particular user, and a second call-up device, which can be assigned to a second user, etc., is provided, for example, for each seating element.

In an embodiment, the system can, for example, include just one call-up device. The system can, for example, include just one call-up device for each seating element of the upholstered furniture.

The upholstered furniture can, for example, have electrical functions so that at least one function is provided which includes a motorized movement of a section of the furniture in two opposing directions and a locking of this section in a plurality of intermediate positions. In order to actuate this function, at least one set-up actuating device can, for example, be provided, advantageously on the call-up device. Both movement directions of just one section of the furniture can, for example, be actuated with the same set-up actuating device, advantageously steplessly.

This enables a prerequisite to reduce the required number of control elements and to increase user convenience and the visual appearance of the upholstered furniture to be achieved.

The set-up actuating device advantageously allows just two switch positions.

The set-up actuating device advantageously includes an electrical switch or is formed thereby. This switch is also described as a “set-up switch” within the framework of this publication. It is basically conceivable that the set-up switch includes a changeover switch (on-on). This switch can, for example, include an on switch (on-off) or be formed thereby. This switch can, for example, switch electrical current after operation, for example, after mechanical, for example, manual, operation. This switch advantageously includes a switching element and, further advantageously, an actuating part. The actuating part is advantageously arranged on the switching element. The transmission between the switching element and the actuating part advantageously takes place mechanically. This switch advantageously closes the contact only for as long as it is actuated. In the non-actuated state, this switch can, for example, make no electrical connection. This switch can, for example, include a press switch and, for example, a pushbutton.

A controller can, for example, be provided which, when the set-up actuating device is actuated once, generates a control signal which effects a movement of the furniture section in one direction, for example, for as long as it is actuated.

Means can, for example, be provided which lock this furniture section in the current position when the set-up actuating device is not actuated. These means can include a self-locking gear, a movement-effecting sliding armature motor, with which the armature is pressed against a brake lining in the current-free state, or a motor brake. The means can, for example, include a relay which short-circuits the at least one movement-effecting motor at standstill, which causes a braking effect against lowering under load.

When the set-up actuating device is again actuated within a certain time after the previous actuation, the controller can, for example, generate a control signal which effects a movement of the section of furniture in the opposite direction. The controller can, for example, include an electronic circuit, for example, a pendulum circuit.

This provides a particularly advantageous way of controlling both movement directions of a section of furniture with the same set-up actuating device.

The present invention also provides a method for operating an upholstered furniture system having an item of upholstered furniture which has electrical functions and can therefore assume different states, wherein at least one device for setting up the different states, a storage device for storing the different states, and at least one device for calling up the stored states are provided, and stored states can, for example, be called up with a different device from that with which they were set up.

Different states can, for example, be stored in a defined order. The order of the stored states can, for example, be defined by the set-up device.

Just one predetermined state of the stored states can, for example, be assigned to a particular number of repeated actuations of the call-up actuating device, for example, within a certain time period. A double consecutive actuation of the call-up device within a certain time period can, for example, be linked with the state stored in position two and, for example, lead to the item of furniture automatically assuming this state.

The preferences of the user regarding the way in which the upholstered furniture is to assume the respective state can, for example, also be stored for each state stored by the storage means. Whether the position of the backrest or the position of the footrest is changed first, or whether this occurs simultaneously, is, for example, here stored.

The present invention is explained in greater detail based on an exemplary embodiment shown in the drawings.

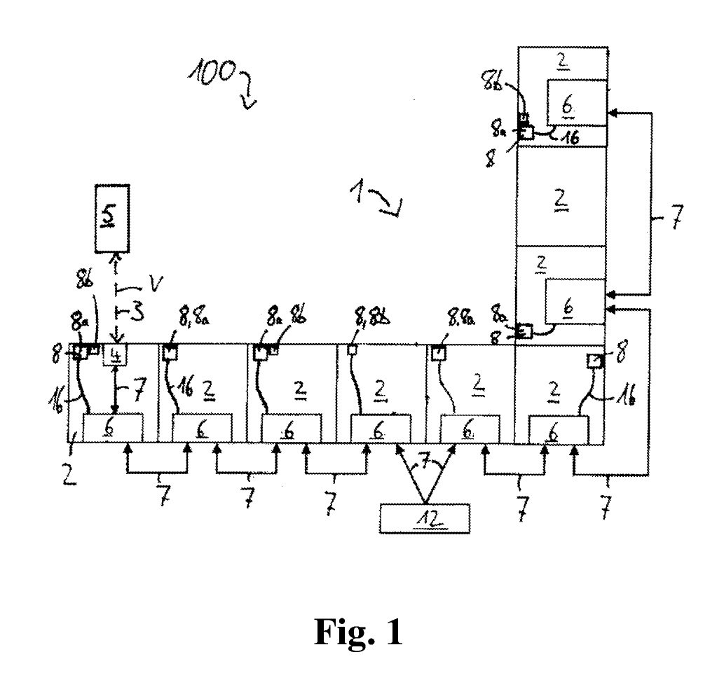

The upholstered furniture system shown in FIG. 1 and designated as a whole by 100 includes an item of upholstered furniture 1 for up to nine people. Eight of the nine seating elements 2 each have just one control unit 6. Each control unit controls the electrical functions of the respective seating element 2.

To actuate these control units 6, each control unit 6 is connected by an electrical control cable 16 to a local input device 8, which is arranged on the respective seating element 2. Depending on whether the respective seating element has the electrical functions of motorized adjustment and/or seat heating, the local input device 8 includes a first pushbutton board 8a and/or a second pushbutton board 8b.

The upholstered furniture system 100 includes a control system 3 which provides a further way of actuating the control units 6. For the entire upholstered furniture 1, the control system 3 includes just one communications terminal 4, which, in the exemplary embodiment shown in FIG. 1, is arranged in the seating element 2 on the extreme left. In another conceivable exemplary embodiment, the communications terminal 4 is arranged in the seating element 2 on the extreme right in FIG. 1.

In the shown exemplary embodiment, the communications terminal 4 is formed by a communications box. This provides a Wi-Fi connection to a mobile input device 5, which can in particular be a commercially available tablet computer or smartphone. The actuating signals entered into the mobile input device 5 are transmitted to the communications terminal 4 via this wireless connection V. In order to pass these actuating signals from the communications terminal 4 to the control units 6, the communications terminal 4 is connected to the control units 6 by an electrical connecting cable 7. The electrical connecting cable 7 includes a bus for data transmission. The electrical connecting cable 7 includes the power supply for the communications terminal 4 and the control units 6, as the electrical connecting cable 7 connects the control units 6 and the communications terminal 4 to a power supply 12.

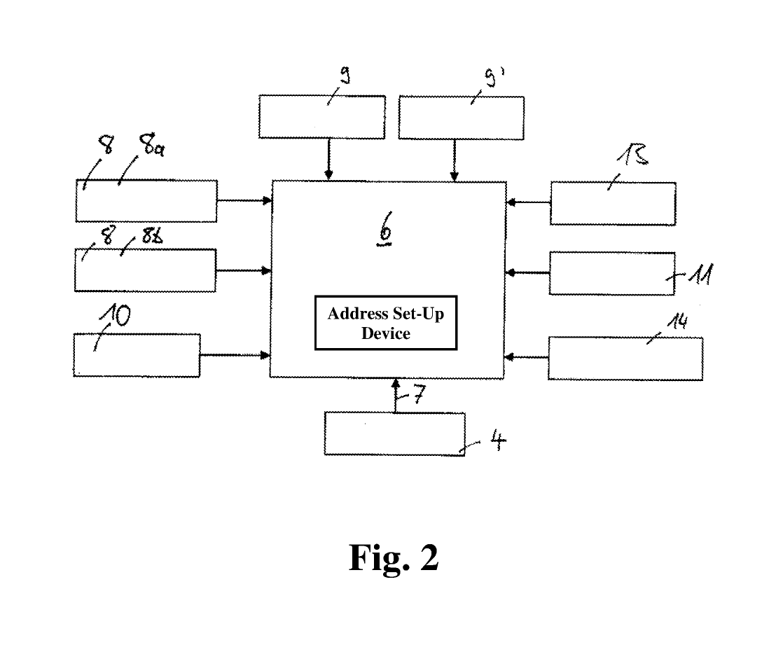

FIG. 2 shows a control unit 6 of a seating element 2 which is fully equipped with regard to electrical functions. The two motors 9, 9′ for effecting the motorized adjustment of the seating element 2 are connected to this control unit 6. A massage unit 13 is also connected as well as seat heating 11 and a USB charging unit 14. The associated seating element 2 is equipped with a seat-occupied sensor 10 which is likewise connected to this control unit 6. Actuation is via the local input device 8, which, in the exemplary embodiment of the control unit shown in FIG. 2, includes a first pushbutton board 8a and a second pushbutton board 8b. The supply of electrical energy and the actuating signals entered via the mobile input device 5 takes place via the electrical connecting cable 7.

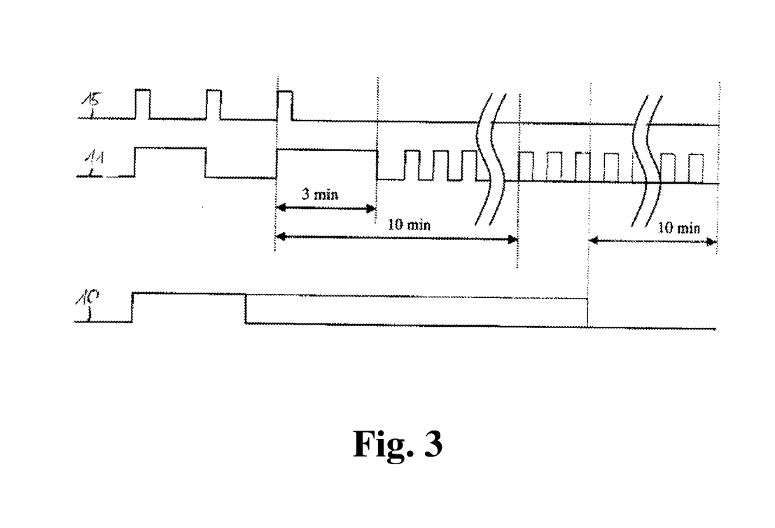

As can be seen from FIG. 3, the output of the control units provides a pulsed DC signal for the heating with an amplitude equal to the magnitude of the supply voltage. The heating is switched on and off via the button 15 of the second pushbutton board 8b. If the heating is off, pressing the button 15 switches the heating on. When the heating is activated, pressing the button 15 switches the heating function off. After switching on, the heating is heated with a continuous pulse of three minutes, then held at the temperature by a pulsed voltage (approximately 1-Hz period) as long as the seat-occupied sensor 10 signals that the respective seating element 2 is occupied, but for at least ten minutes. If the seat-occupied sensor 10 signals that the respective seating element 2 is no longer occupied, the heating then switches off after ten minutes. A renewed signaling of seat occupation by the occupied sensor 10 within the ten minutes resets the time.

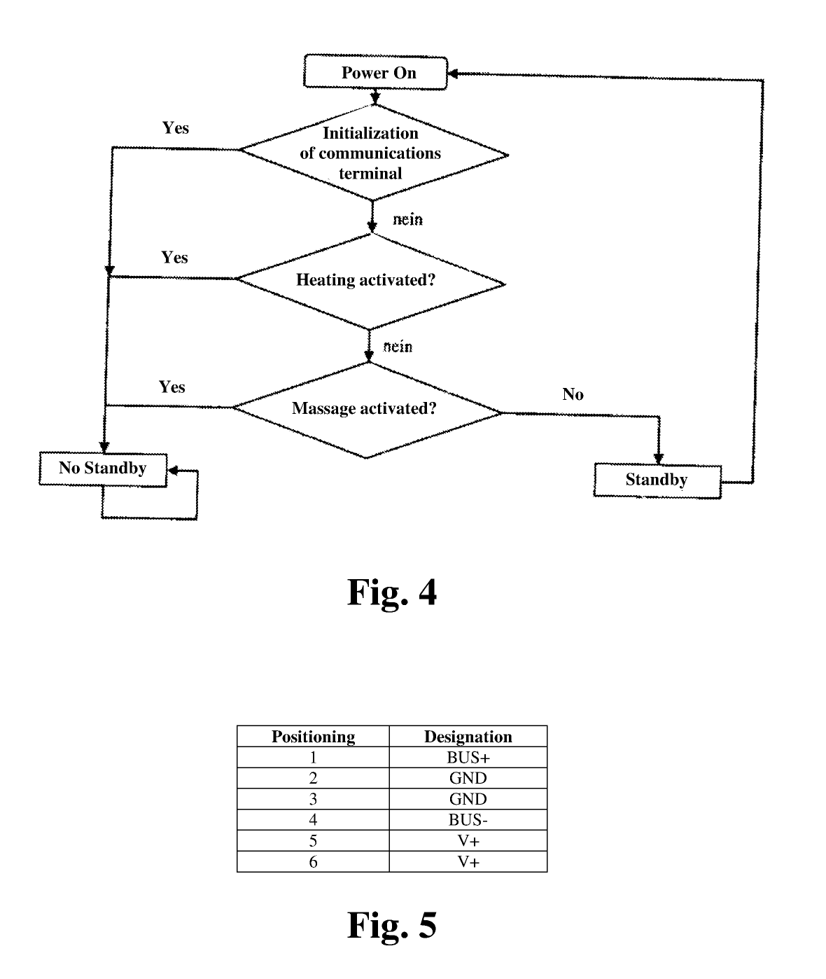

FIG. 4 shows a schematic of a possible standby function of a control unit. This is basically conceivable, particularly in the case of battery operation.

FIG. 5 shows the assignment of the six-core electrical cable 7 which connects the communications terminal 4 to a control unit 6 and this control unit 6 to the rest of the control units 6. As FIG. 5 shows, two cores, namely V+ and GND, are used in parallel.

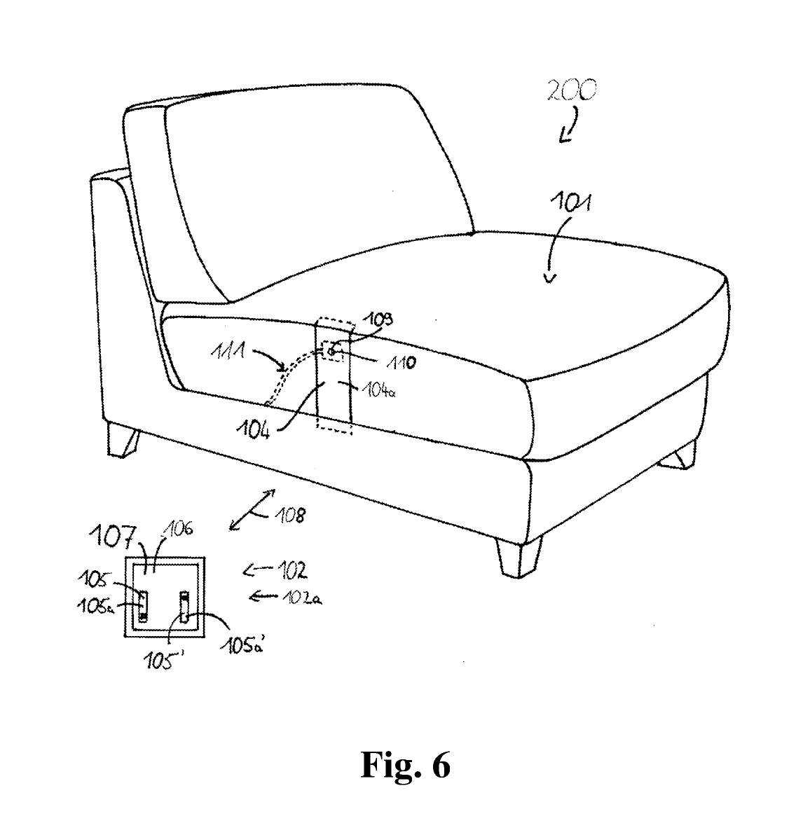

The item of upholstered furniture 101 of the upholstered furniture system 200 according to the invention shown in FIG. 6 is an item of furniture which has electrical functions and can therefore assume different states. The inclination of the backrest can, for example, be changed by an electric motor, or the item of furniture 101 can have a headrest (not shown in the drawings), the inclination of which can be changed by an electric motor. It is also conceivable that a footrest (likewise not shown in the drawings), which can be extended by an electric motor, can also be provided.

These different states can be adapted to suit different users and/or different situations (for example reading, watching television, reclining, or starting heating). These states can be stored by the storage means. Five different states can, for example, be stored.

These states can be set up with the help of the set-up device 102 which, in the exemplary embodiment shown, is realized as a mobile input device 102a and comprises a tablet computer.

The set-up device 102 has a plurality of actuating devices 105, 105′ which, in the shown exemplary embodiment, are realized by way of example as two symbolized slide switches 105a, 105a′. The set-up device 102 also has means 106 for visually reproducing changing functions which, in the shown exemplary embodiment, comprise a display 107 which also provides the symbols for these slide switches. The display 107 is realized as a touchscreen, i.e., touch-sensitive, and the user can actuate the displayed actuating devices 105, 105′ of the set-up device 102 by touching and moving. The set-up device 102 is operatively connected to the item of furniture 101 by a radio link 108. The radio link 108 can be unidirectional or bidirectional.

A required state of the item of furniture 101 can be set up by the input device 102. For example, via the actuating device 105 shown on the left, the inclination of the backrest can be adjusted by an electric motor and, via the actuating device 105′ shown on the right, the inclination of the headrest (not shown in the drawings), and the state with the required inclinations set up in this manner can be stored, for example, by a particular actuation of the set-up device 102 or/and the call-up device 104.

The set-up device 102 is not required in order to call up this state again. This is because the state set up via the set-up device 102 can be called up with the help of the call-up device 104. This is permanently arranged on the rest of the upholstered furniture 101 and includes just one call-up actuating device 109 with just one call-up switch 110 which allows just two switch positions. In the exemplary embodiment shown in FIG. 1, the call-up device has exclusively this call-up actuating device and no further actuating device. In order to be able to call up a plurality of different states, for example, five, a device is provided which assigns just one pre-defined stored state to a particular number of repeated actuations of the call-up device 104, in the shown exemplary embodiment the call-up switch 110, within a defined period. The user can log in via this call-up switch, which can also be described as an “ident button,” and call up the required state semi-automatically. If, for example, the fourth stored setting, e.g. “Relax in TV Position,” is to be called up, then all that is necessary is for the user to press the “ident button” four times. Individual comfort settings can therefore be stored with the help of a mobile device (mobile input device 102a) and called up semi-automatically (with the help of the call-up device 104) without mobile input device 102a. Different states can thereby be set up and stored quickly and conveniently, and they can be called up very easily and quickly from the item of furniture 101 without mobile input device 102a. The device which assigns just one pre-defined stored state to a particular number of repeated actuations of the call-up device within a defined period can include an electronic circuit, for example, an integrated circuit.

Control signals can emanate from this device, for example, via an electrical cable 111 to electric motors (not shown in the drawings).

In the exemplary embodiment shown in FIG. 6, a state cannot be set up with the call-up device 104 and, in this exemplary embodiment, only states which have already been stored can be called up with the call-up device 104. Different states can here therefore only be set up with the set-up device 102.

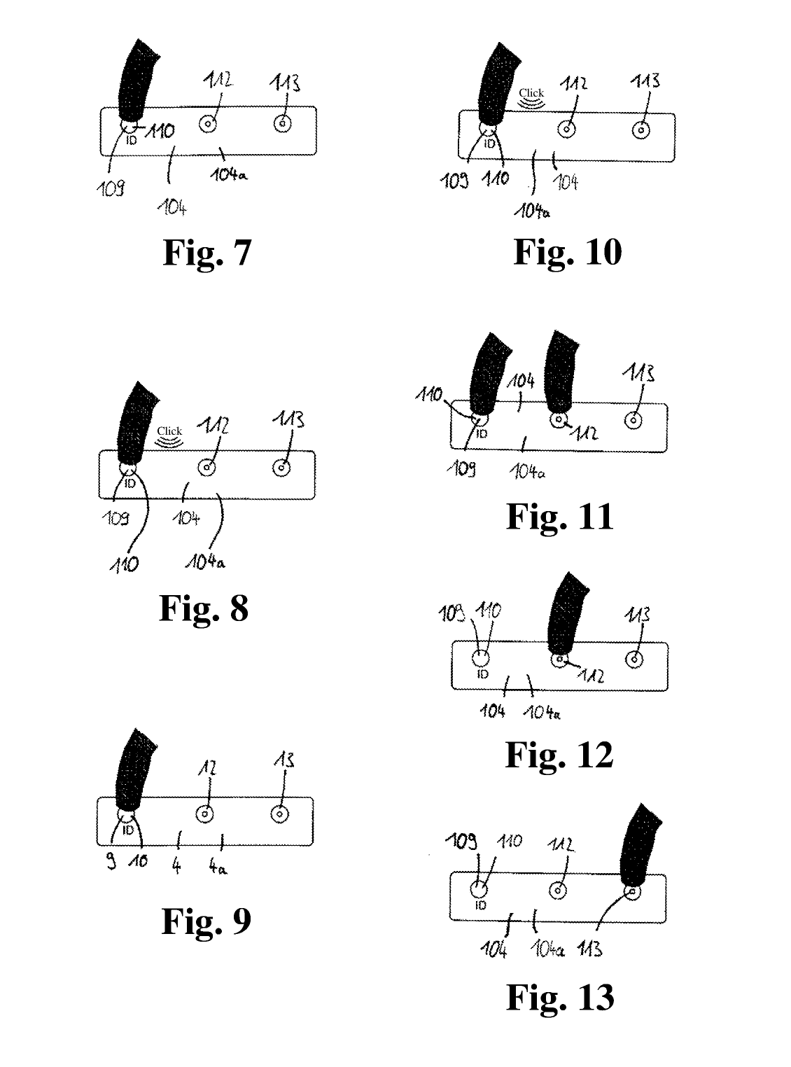

FIGS. 7 to 13 show a call-up device 104 of a further exemplary embodiment of an upholstered furniture system 200.

In this exemplary embodiment, a state can also be set up with the call-up device 104.

Unlike the call-up device 104 shown in FIG. 6, in addition to the call-up actuating device 109, which is realized in the same way as the call-up actuating device 109 shown in FIG. 6, this call-up device 104 has further control elements which are realized as set-up actuating devices 112, 113. The set-up actuating devices 112, 113 are realized as set-up switches and, more accurately, as pushbuttons.

In the exemplary embodiment of the upholstered furniture system 200 of the call-up device 104 shown in FIGS. 7 to 9, a set-up device (not shown in FIGS. 7-9) is shown which is separate from the call-up device 104. Different states can here therefore be set up both by this set-up device and by the call-up device 104 shown in FIGS. 7 to 9.

When, as shown in FIG. 7, the call-up actuating device 109 of the call-up device is actuated and held, for example, for more than 10 seconds, an audible signal then sounds and the Wi-Fi Protected Setup (WPS) is opened. The addition of a device, in particular a set-up device, or, in other words, the establishment of a radio link to a set-up device, is now possible for a limited time. When this time has expired, a second audible signal sounds and the Wi-Fi Protected Setup (WPS) is closed once more.

FIG. 8 shows the calling-up of a state which has already been set up and stored. Just one pre-defined state of the stored states is assigned to a repeated actuation of the call-up actuating device (for example up to five times) which is carried out within a defined period, for example, less than 0.5 seconds between two actuations. The item of upholstered furniture then assumes this state automatically if this has been released in the App. It in particular moves into the stored, required position for the particular user. This takes place in accordance with the preferences stored for the respective state. An audible signal is sounded as confirmation of the input.

FIG. 9 clarifies the option of returning the upholstered furniture to the starting position. On actuating the call-up actuating device 109 and holding the call-up actuating device for a defined time, for example, for more than 2 seconds (but less than 10 seconds), the upholstered furniture assumes its starting position in which, for example, all motors are in 0-position. An audible signal can be sounded as confirmation of this input. If the upholstered furniture is already in the starting position, then a double audible signal can be sounded.

In the exemplary embodiment of the upholstered furniture system 200 of the call-up device 104 shown in FIG. 10, no set-up device which is separate from the call-up device 104 is provided. The different states, or the at least one state which is different from the starting position, can here therefore only be set up with the call-up device 104, for example, as explained in conjunction with FIG. 11. The call-up can then take place as follows: For example, on actuating the call-up actuating device 109 and holding for less than half a second, the upholstered furniture automatically assumes a different state. If, on actuation, the item of furniture is in the starting position, then a state which has been set up and stored is assumed. If, on actuation, the item of furniture is not in the starting position, then, advantageously, this is assumed. An audible signal can be sounded for confirmation.

The functionality of the control elements of the call-up device 104 shown in FIGS. 11 to 13 can be present in exemplary embodiments of the upholstered furniture system with set-up device 102 which is different from the call-up device 104 as well as in exemplary embodiments in which no set-up device 102 which is different from the call-up device 104 is provided.

On simultaneously actuating the call-up actuating device 109 shown in FIG. 11 and a set-up actuating device 112 and, for example, holding for more than 1 second, the state which has previously been steplessly set up, for example, with the help of the set-up actuating devices 112, 113, can be saved. An audible confirmation signal can be sounded. The state is saved for the logged-in or selected user, or for the logged-in or selected situation, via the storage means, which can be part of the communications terminal. In so doing, a possibly already-existing state with regard to user or situation is overwritten regardless of whether it was set up using the mobile input device or the local device. The appropriate state which was last stored is therefore relevant.

FIGS. 12 and 13 show the functionality of the set-up actuating devices 112, 113. A movement of a section of the upholstered furniture in two opposing directions and locking of this section in a plurality of intermediate positions can be controlled with either of the two set-up actuating devices 112, 113.

The actuation and holding of the set-up actuating device 112 shown in FIG. 12 starts a movement of the section of the upholstered furniture associated with this set-up actuating device 112, for example, the backrest, from an end position, or this section moves in the direction opposing the last direction in accordance with a pendulum circuit. The movement here lasts as long as the set-up actuating device 112 is held.

The actuation and holding of the other set-up actuating device 113 shown in FIG. 12 starts a movement of the section of the upholstered furniture associated with this set-up actuating device 113, for example, the headrest, from an end position, or this section moves in the direction opposing the last direction in accordance with a pendulum circuit. If possible, the headrest must here always open first, i.e., become flatter and not steeper. Initiated automatic movements and associated movements are therefore not evaluated for the initiation of the pendulum circuit by the set-up actuating device which is associated with the headrest.

In the upholstered furniture systems 200 of the call-up device 104 shown in FIGS. 7 to 13, the item of upholstered furniture or the seating element of the item of upholstered furniture on which the call-up device 104 is arranged has just two sections, the position of which can be changed. Just one set-up actuating device 112, 113 is associated with each of these sections. The number of set-up actuating devices 112, 113 therefore corresponds to the number of variable-position sections. It is conceivable that the upholstered furniture 1, 101, or each seating element, has more or less than just two variable-position sections and the number of set-up actuating devices varies accordingly.

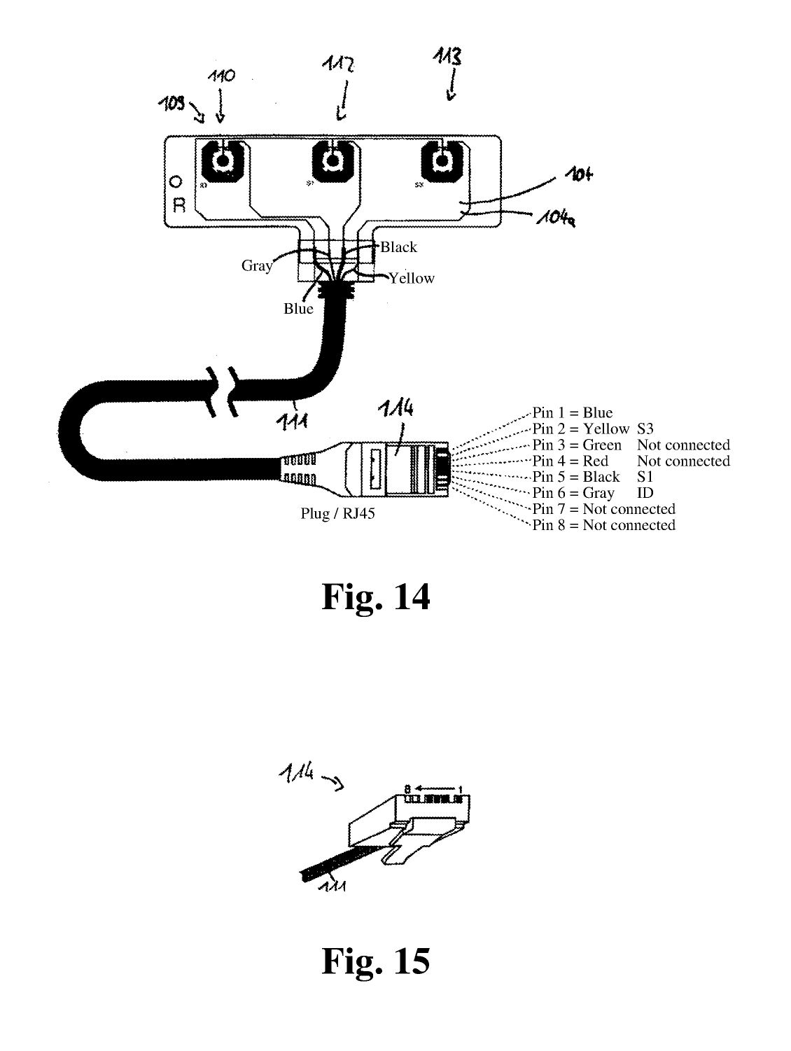

FIGS. 14 and 15 clarify an exemplary design of a circuit board and of the switch.

### LIST OF REFERENCE NUMERALS

100, 200 Upholstered furniture system
1 Item of upholstered furniture
2 Seating element
3 Control system
4 Communications terminal
5 Mobile input device
6 Control units
7 Electrical connecting cable and bus
8 Local input device
8a First pushbutton board
8b Second pushbutton board
9, 9 Motor
10 Seat-occupied sensor
11 Seat heating
12 Power supply
13 Massage unit
14 USB charging unit
15 Button of the second pushbutton board
16 Electrical control cable
101 Item of upholstered furniture
102 Set-up device
102a Mobile input device
104 Call-up device
104a Local input device
105, 105 Actuating device of the set-up device
105a, 105a′ Symbolized slide switch
106 Means for visually reproducing changing information
107 Display
108 Radio link
109 Call-up actuating device
110 Call-up switch
111 Electrical cable
112, 113 Set-up actuating devices
114 Plug
V Wireless connection

1-21. (canceled)

22. An upholstered furniture system comprising an item of upholstered furniture comprising;
electrical functions;
at least one seating element; and
a control system comprising,
a mobile input device,
a communications terminal, and
at least one control unit is arranged on the item of upholstered furniture, the at least one control unit being operatively connected to the communications terminal.

23. The system as recited in claim 22, wherein,
the at least one control unit is configured to control the electrical functions of the upholstered furniture, and
the control system further comprises,
software which is configured to work on the mobile input device, and
a wireless connection between the mobile input device and the communications terminal.

24. The system as recited in claim 23, wherein the at least one seating element is provided as a plurality of seating elements, the plurality of seating elements being networked with each other.

25. The system as recited in claim 22, wherein,
the control system further comprises a bus system,
the at least one control unit is provided as a plurality of control units arranged on the item of upholstered furniture, and
the communications terminal is operatively connected to the plurality of control units by the bus system.

26. The system as recited in claim 25, wherein,
the control system further comprises at least one local input device which is arranged permanently on the item of upholstered furniture, and
each of the at least one local input device is operatively connected to only one of the plurality of control units.

27. The system as recited in claim 22, wherein the electrical functions comprise at least one of:
a motorized adjustability of the at least one seating element,
a massage function of the at least one seating element,
a seat heating of the at least one seating element,
at least one activatable and adjustable lumbar support of at least one seating element, and
at least one USB charging unit of the at least one seating element.

28. The system as recited in claim 27, wherein the motorized adjustability of the at least one seating element is provided by two electric motors, each of the two electric motors comprising two sensors for measuring an actual motor position.

29. The system as recited in claim 27, wherein the control system further comprises a memory function for the at least one seating element, the memory function being configured so that a position of the motorized adjustability of the at least one seating element selected by a user is storable and recallable.

30. The system as recited in claim 27, wherein,
the item of upholstered furniture further comprises at least one seat-occupied sensor which is configured to emit signals relating to an occupancy of the item of upholstered furniture, and
the control system is configured to perform an automatic activation and deactivation of the seat heating which is dependent on the signals of the at least one seat-occupied sensor.

31. The system as recited in claim 22, wherein the control system further comprises a lock principle which prevents a simultaneous access of more than one mobile input device to the same at least one seating element.

32. The system as recited in claim 22, wherein,
the item of upholstered furniture is configured to assume different states, and
the item of upholstered furniture further comprises,
at least one set-up device configured to set up the different states,
a storage device configured to store the different states, and
at least one call-up device configured to call-up the different states which have been stored.

33. The system as recited in claim 32, wherein the at least one call-up device is provided separately from the at least one set-up device.

34. The system as recited in claim 32, wherein,
the item of upholstered furniture further comprises a plurality of actuating devices, and
the at least one set-up device is further configured to make available the plurality of actuating devices.

35. The system as recited in claim 32, wherein the at least one set-up device comprises a device which is configured to visually reproduce changing information, the device comprising a display.

36. The system as recited in claim 32, wherein,
the item of upholstered furniture further comprises a radio link, and
the at least one set-up device is operatively connected to a rest of the upholstered furniture system via the radio link.

37. The system as recited in claim 36, wherein the at least one set-up device comprises the mobile input device.

38. The system as recited in claim 32, wherein the at least one call-up device is arranged on a rest of the upholstered furniture system.

39. The system as recited in claim 32, wherein the at least one call-up device comprises one call-up switch which is configured to only allow two switch positions.

40. The system as recited in claim 32,
the item of upholstered furniture further comprises an assignment device which is configured to assign only one pre-defined stored state to a particular number of repeated actuations of the at least one call-up device within a defined period.

41. An item of upholstered furniture comprising the upholstered furniture system as recited in claim 22.

42. A method for operating an upholstered furniture system, the method comprising:
providing an item of upholstered furniture which is configured to assume different states, the item of upholstered furniture comprising,
electrical functions,
at least one seating element,
a control system comprising,
a mobile input device,
a communications terminal, and
at least one control unit is arranged on the item of upholstered furniture, the at least one control unit being operatively connected to the communications terminal,
at least one set-up device which is configured to set up the different states,
a storage device which is configured to store the different states, and
at least one call-up device which is configured to call-up the different states which have been stored; and
storing the different states via the at least one storage device.

43. The method as recited in claim 42, further comprising calling up the stored different states via the at least one call-up device.
